(19) United States
(12) Patent Application Publication
(10) Pub. No.: US 2012/0018304 A1
(43) Pub. Date: Jan. 26, 2012

(54) OXYGEN SENSOR ELEMENT AND OXYGEN SENSOR

(75) Inventors: Takao MIKAMI, Yokkaichi-shi (JP); Motoaki Satou, Anjo-shi (JP)

(73) Assignee: DENSO CORPORATION, Kariya-city (JP)

(21) Appl. No.: 13/188,009

(22) Filed: Jul. 21, 2011

(30) Foreign Application Priority Data
Jul. 21, 2010 (JP) 2010-163803

(51) Int. Cl. G01N 27/409

(52) U.S. Cl. 204/427

(57) ABSTRACT

An oxygen sensor element 1 includes: a cup-shaped solid electrolyte body 10, inside of which a reference gas chamber 13 is provided; a measuring electrode 11 that comes into contact with measured gas; and a reference electrode 12. A heater 2 is disposed inside the reference gas chamber 13. The measuring electrode 11 is formed surrounding the outer surface 101 in a tip end section 100 of the solid electrolyte body 10. The reference electrode 12 is formed in a measuring-electrode-opposing-region 102a that is a region on the inner surface 102 of the solid electrolyte body 10 opposing the measuring electrode 11 with the solid electrolyte body 10 therebetween. The area S1 of the measuring electrode 11 and the area S2 of the reference electrode 12 satisfy a relationship 0.010≦S2/S1<0.723.

### CROSS REFERENCE TO RELATED APPLICATION

This application is based upon and claims the benefit of priority from the prior Japanese Patent Application No. 2010-163803, filed Jul. 21, 2010, the entire contents of which is incorporated herein by reference.

### BACKGROUND OF THE INVENTION

1. Field of the Invention

The present invention relates to an oxygen sensor element provided in an oxygen sensor used for combustion control in a vehicle internal combustion engine and the like, and an oxygen sensor including the oxygen sensor element.

2. Description of the Related Art

An oxygen sensor is used for combustion control in vehicle internal combustion engines and the like.

As an oxygen sensor element provided in the oxygen sensor, for example, an oxygen sensor element having a following configuration is known. In the oxygen sensor element, a cup-shaped solid electrolyte body having a closed tip end and an open base end, and inside of which a reference gas chamber is provided, serves as a partition wall. A measuring electrode is provided on the outer surface of the solid electrolyte body, and a reference electrode is provided on the inner surface thereof. A heater is disposed such as to be inserted into the reference gas chamber within the solid electrolyte body. In the oxygen sensor element, the measuring electrode is exposed to exhaust gas, and the reference electrode is exposed to atmosphere serving as reference. Oxygen concentration is measured based on voltage generated between the two electrodes as a result of difference in oxygen concentration between the atmosphere and the exhaust gas.

In the oxygen sensor element, a noble metal material such as platinum is used as an electrode (measuring electrode and reference electrode) material. Sensor output is achieved by the catalytic action of the noble metal element. Noble metal materials such as platinum are expensive. Therefore, to reduce manufacturing cost, reducing the amount of noble metal material used is an essential issue.

For example, US Patent Publication No. 2003/0196596 A1 (corresponding Japanese Unexamined Patent Publication No. 2003-80153) discloses an active liquid applicator for applying a thin active membrane of an electrode or the like on the surface of an electronic component. US Patent Publication No. 2006/0228495 A1 (corresponding Japanese Unexamined Patent Publication No. 2006-292759) discloses a method for manufacturing an exhaust gas sensor. In both technologies, excess electrode materials, such as noble metals, can be eliminated.

In addition, U.S. Pat. No. 6,354,134 (corresponding Japanese Unexamined Patent Publication No. H11-153571) discloses an oxygen sensor element in which a measuring electrode is formed on only the tip end section (detecting section) of the oxygen sensor element that becomes high temperature, and a reference electrode is formed in a position opposing the measuring electrode with a solid electrolyte body therebetween. As a result, formation area of the electrodes is reduced, thereby reducing the amount of electrode material used and the manufacturing cost of the oxygen sensor element.

In the oxygen sensor element, sensor output changes when element temperature changes. Therefore, to stabilize sensor output, the temperature of the oxygen sensor element is required to be controlled. In general, the element temperature is determined by monitoring element resistance, using a characteristic in that the impedance of the solid electrolyte body has a one-to-one relationship with the temperature (temperature characteristics of resistance of the oxygen sensor element). As a result of the element temperature being adjusted such that the element resistance is kept within a constant range, the temperature of the oxygen sensor element is controlled to be within a constant range.

In recent years, in view of improving fuel efficiency and catalytic purification, there has been a demand for an oxygen sensor element capable of being used in a high-temperature environment of 550° C. or higher. Therefore, an oxygen sensor element is desired that has minimal temperature variation in a high-temperature environment.

However, in the oxygen sensor element disclosed in above-described U.S. Pat. No. 6,354,134, impedance variation in relation to temperature tends to be small in a high-temperature environment of 550° C. or higher. Moreover, in a typical oxygen sensor element as well, in which the thickness of the partition wall cannot be increased to shorten active time, the impedance variation in relation to temperature is small particularly in a high-temperature environment of 550° C. or higher. Therefore, the temperature of the oxygen sensor element cannot be controlled with high accuracy. A problem occurs in that temperature variation in the oxygen sensor element increases.

### SUMMARY OF THE INVENTION

The present invention has been achieved to solve the above-described issues. An object of the present invention is to provide an oxygen sensor element capable of controlling element temperature with higher accuracy and reducing cost by reducing electrode materials.

According to one aspect of the present invention, there is provided an oxygen sensor element, including: a cup-shaped solid electrolyte body having a closed tip end and an open base end, and inside of which a reference gas chamber is provided; a measuring electrode that is formed on an outer surface of the solid electrolyte body and comes into contact with measured gas; and a reference electrode that is formed on an inner surface of the solid electrolyte body. A heater is disposed such as to be inserted into the reference gas chamber. In the oxygen sensor element, the measuring electrode is formed surrounding the outer surface in a tip end section of the solid electrolyte body. The reference electrode is formed in a measuring-electrode-opposing-region that is a region on the inner surface of the solid electrolyte body opposing the measuring electrode with the solid electrolyte body therebetween. The area S1 of the measuring electrode and the area S2 of the reference electrode satisfy a relationship 0.010≦S2/S1<0.723.

The inventors of the present invention have discovered that a gradient of impedance of the solid electrolyte body in relation to temperature of the oxygen sensor element (referred to accordingly, hereinafter, as “temperature gradient”) can be increased by reducing the area S2 of the reference electrode in relation to the area S1 of the measuring electrode by a predetermined range. When the temperature gradient of the solid electrolyte body is increased in this way, the temperature of the oxygen sensor element can be more accurately determined by detecting impedance. Therefore, in the first invention, stable sensor output can be achieved by controlling the temperature of the oxygen sensor element to a desired temperature with higher accuracy.

In addition, because the area S2 of the reference electrode in relation to the area S1 of the measuring electrode is reduced by a predetermined range, compared to when the area S1 of the measuring electrode is fixed and the reference electrode is formed in the overall measuring-electrode-opposing-region, electrode formation area of the reference electrode can be reduced. Therefore, in the first invention, the amount of use of an electrode material containing a noble metal such as platinum can be reduced, thereby reducing cost.

According to another aspect of the present invention, there is provided an oxygen sensor element, including: a cup-shaped solid electrolyte body having a closed tip end and an open base end, and inside of which a reference gas chamber is provided; a measuring electrode that is formed on an outer surface of the solid electrolyte body and comes into contact with measured gas; and a reference electrode that is formed on an inner surface of the solid electrolyte body. A heater is disposed such as to be inserted into the reference gas chamber. In the oxygen sensor element, the reference electrode is formed surrounding the inner surface in a tip end section of the solid electrolyte body. The measuring electrode is formed in a reference-electrode-opposing-region that is a region on the outer surface of the solid electrolyte body opposing the reference electrode with the solid electrolyte body therebetween. The area S2 of the reference electrode and the area S1 of the measuring electrode satisfy a relationship 0.05≦S1/S2<1.38

Contrary to the above-described first aspect, the second aspect is very characteristic in that the temperature gradient is found to have increased by reducing the area S1 of the measuring electrode in relation to the area S2 of the reference electrode by a predetermined range. Like the first aspect, because the temperature gradient increases, the temperature of the oxygen sensor element can be more accurately determined by detecting impedance. Therefore, in the second aspect, stable sensor output can be achieved by controlling the temperature of the oxygen sensor element to a desired temperature with higher accuracy.

In addition, because the area S1 of the measuring electrode in relation to the area S2 of the reference electrode is reduced by a predetermined range, compared to when the area S2 of the reference electrode is fixed and the measuring electrode is formed in the overall reference-electrode-opposing-region, electrode formation area of the measuring electrode can be reduced. Therefore, in the second invention, the amount of use of an electrode material containing a noble metal such as platinum can be reduced, thereby reducing cost.

According to a further aspect of the present invention, there is provided an oxygen sensor including oxygen sensor element according to the above first aspect.

According to a still further aspect of the present invention, there is provided an oxygen sensor including oxygen sensor element according to the above second aspect.

### BRIEF DESCRIPTION OF THE DRAWINGS

The invention will be more particularly described with reference to the accompanying drawings in which:

FIG. 1 is an explanatory diagram of an oxygen sensor element according to a first embodiment of the present invention;

FIG. 2 is an explanatory diagram of an internal structure of the oxygen sensor element according to the first embodiment;

FIG. 3 is an enlarged view of the internal structure of the oxygen sensor element according to the first embodiment;

FIG. 4 is an explanatory diagram of a structure of an oxygen sensor according to the first embodiment;

FIG. 5 is an explanatory diagram of an internal structure of an oxygen sensor, element according to a second embodiment;

FIG. 6A is an explanatory diagram of the internal structure of the oxygen sensor element according to the second embodiment, and FIG. 6B is a cross-sectional view taken along line A-A in FIG. 6A;

FIG. 7 is an explanatory diagram of the internal structure of the oxygen sensor element according to the second embodiment;

FIG. 8 is an enlarged view of the internal structure of the oxygen sensor element according to the second embodiment;

FIG. 9 is an explanatory diagram of a relationship between element temperature and element resistance Zac according to the second embodiment;

FIG. 10 is an explanatory diagram of an oxygen sensor element according to a third embodiment;

FIG. 11 is an explanatory diagram of an internal structure of the oxygen sensor element according to the third embodiment;

FIG. 12 is an enlarged view of the internal structure of the oxygen sensor element according to the third embodiment;

FIG. 13 is an explanatory diagram of an oxygen sensor element according to a fourth embodiment;

FIG. 14 is an explanatory diagram of the oxygen sensor element according to the fourth embodiment; and

FIG. 15 is an explanatory diagram of the oxygen sensor element according to the fourth embodiment.

### DETAILED DESCRIPTION OF THE PREFERRED EMBODIMENTS

An oxygen sensor element and an oxygen sensor according to the preferred embodiments of the present invention will hereinafter be described with reference to the drawings.

In the first embodiment and the second embodiment, a temperature gradient that is a gradient of impedance of a solid electrolyte body in relation to temperature of an oxygen sensor element can be determined as follows.

The relationship between temperature X(° C.) of the oxygen sensor element and impedance Y(Ω) is expressed by a graph, and an approximate curve (fitted curve) Y=a·b^{x} (b: constant) is derived. As a result, a value of the temperature gradient is determined.

In the first embodiment, a measuring electrode is formed surrounding an outer surface of a tip end section of the solid electrolyte body. In other words, the measuring electrode is formed over the overall periphery in widthwise direction, i.e. perpendicular to the axial direction of the outer surface of the tip end section of the solid electrolyte body.

The measuring electrode can be set such that, for example, a distance from the tip of the solid electrolyte body to the posterior end of the measuring electrode is 50% of the overall length in the axial direction of the solid electrolyte body.

When a relationship between the area S1 of the measuring electrode and the area S2 of the reference electrode is S2/S1<0.010, the area S2 of the reference electrode in relation to the area S1 of the measuring electrode becomes extremely small. Therefore, conduction defect may occur between the measuring electrode and the reference electrode. On the other hand, when S2/S1≧0.723, the effect of the present invention, namely increasing the temperature gradient, may not be sufficiently achieved.

A heater is preferably in contact with a section in which the reference electrode is formed, in a measuring-electrode-opposing-region on the inner surface of the solid electrolyte body. The area S1 of the measuring electrode and the area S2 of the reference electrode preferably satisfy a relationship 0.185≦S2/S1<0.723. In this instance, because the heater is in contact with the reference electrode, active time is shortened and responsiveness increases. Responsiveness in this instance refers to the capability of detecting variation in oxygen concentration without time lag, when the oxygen concentration of a measured gas changes. Because the temperature gradient does not change excessively, the variation in temperature gradient in relation to area ratio S2/S1 can be suppressed.

The reference electrode is preferably continuously formed in the peripheral direction within the measuring-electrode-opposing-region on the inner surface of the solid electrolyte body. An angle formed by the shaft center of the oxygen sensor element and both ends of the reference electrode in the peripheral direction is preferably 10° to 360°. The heater is preferably in contact with the measuring-electrode-opposing-region on the inner surface of the solid electrolyte body, and the reference electrode is preferably formed in at least a portion of the contact section.

In this instance, because the heater is in contact with the reference electrode, the active time is shortened and high responsiveness can be achieved. As a result of the angle in the peripheral direction being changed, the area ratio S2/S1 can be easily changed, and adjustment of the temperature gradient is facilitated.

In addition, the heater is preferably in contact with a section in which the reference electrode is not formed, in the measuring-electrode-opposing-region of the inner surface of the solid electrolyte body. The area S1 of the measuring electrode and the area S2 of the reference electrode preferably satisfy a relationship 0.385≦S2/S1<0.723. In this instance, because the reference electrode is not formed in the contact section with the heater having the lowest resistance value, the temperature gradient can be further increased.

In the second invention, the reference electrode is formed surrounding the inner surface in the tip end section of the solid electrolyte body. In other words, the reference electrode is formed over the overall periphery in the perpendicular to the axial direction of the inner surface in the tip end section of the solid electrolyte body.

The reference electrode can be set such that, for example, a distance from the tip of the solid electrolyte body to the posterior end of the reference electrode is 50% of the overall length in the axial direction of the solid electrolyte body.

When a relationship between the area S2 of the reference electrode and the area S1 of the measuring electrode is S1/S2<0.05, the area S1 of the measuring electrode in relation to the area S2 of the reference electrode becomes extremely small. Therefore, conduction defect may occur between the measuring electrode and the reference electrode.

On the other hand, when S1/S2≦1.38, the effect of the present invention, namely increasing the temperature gradient, may not be sufficiently achieved.

A heater is preferably in contact with a position opposing the measuring electrode on the inner surface of the solid electrolyte body. The area S2 of the reference electrode and the area S1 of the measuring electrode preferably satisfy a relationship 0.41≦S1/S2<1.38. In this instance, because the heater is in contact with the reference electrode, active time is shortened and responsiveness increases. Because the temperature gradient does not change excessively, the variation in temperature gradient in relation to area ratio S1/S2 can be suppressed.

The measuring electrode is preferably formed segmented in the peripheral direction within a reference-electrode-opposing-region on the outer surface of the solid electrolyte body. The heater is preferably at least partially in contact with the position opposing the measuring electrode on the inner surface of the solid electrolyte body. In this instance, because the heater is in contact with the reference electrode and the contact section opposes the measuring electrode, the active time is shortened and responsiveness is increased. In addition, because the measuring electrode is formed divided in the peripheral direction, the area ratio S1/S2 can be easily changed, and adjustment of the temperature gradient is facilitated.

### First Embodiment

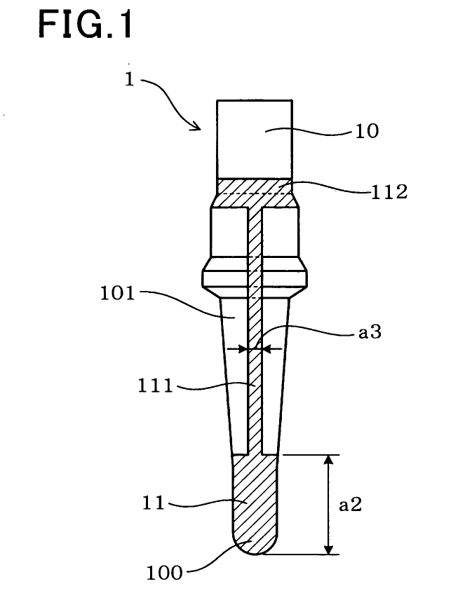

An oxygen sensor element and an oxygen sensor according to an embodiment of the present invention will be described with reference to FIG. 1 to FIG. 4.

As shown in FIG. 1 to FIG. 3, an oxygen sensor element 1 according to a first embodiment has a cup-shaped solid electrolyte body 10 having a closed tip end and an open base end, and inside of which a reference gas chamber 13 is provided. A measuring electrode 11 that comes into contact with a measured gas is formed on an outer surface 101 of the solid electrolyte body 10. A reference electrode 12 is formed on an inner surface 102 of the solid electrolyte body 10. A heater 2 is disposed such as to be inserted into the reference gas chamber 13.

As shown in the drawings, the measuring electrode 11 is formed surrounding the outer surface 101 of a tip end section 100 of the solid electrolyte body 10. The reference electrode 12 is formed within a measuring-electrode-opposing-region 102a that is a region on the inner surface 102 of the solid electrolyte body 10 opposing the measuring electrode 11 with the solid electrolyte body 10 therebetween.

The area S1 of the measuring electrode 11 and the area S2 of the reference electrode 12 satisfy a relationship 0.010≦S2/S1<0.723.

The foregoing will be described below.

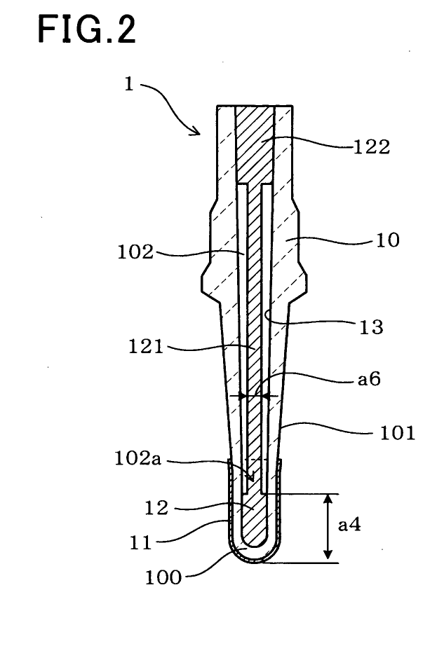

As shown in FIG. 1 and FIG. 2, the oxygen sensor element 1 has the bottomed, cylindrical, cup-shaped solid electrolyte body 10 that is closed on the tip end side and open on the base end side.

As shown in FIG. 1, the measuring electrode 11 is formed on the outer surface 101 of the solid electrolyte body 10. The measuring electrode 11 is formed over the overall periphery in the perpendicular to the axial direction such as to surround the outer surface 101 of the tip end section 100 of the solid electrolyte body 10.

An outer lead section 111 and an outer terminal section 112 that conduct current to the measuring electrode 11 are formed on the outer surface 101 of the solid electrolyte body 10.

As shown in FIG. 2, the reference electrode 12 is formed on the inner surface 102 of the solid electrolyte body 10. The reference electrode 12 is formed within the measuring-electrode-opposing-region 102a that is a region on the inner surface 102 of the solid electrolyte body 10 opposing the measuring electrode 11 with the solid electrolyte body 10 therebetween.

According to the first embodiment, the reference electrode 12 is formed over the overall periphery in the perpendicular to the axial direction on the tip end side of the measuring-electrode-opposing-region 102a.

An inner lead section 121 and an inner terminal section 122 are formed on the inner surface 102a of the solid electrolyte body 10 to conduct current to the reference electrode 12.

As shown in FIG. 1 and FIG. 2, with an electrode formation area of the measuring electrode 11 formed on the outer surface 101 of the solid electrolyte body 10 as S1 and an electrode formation area of the reference electrode 12 formed within the measuring-electrode-opposing-region 102a on the inner surface 102 of the solid electrolyte body 10 as S2, a relationship 0.010≦S2/S1<0.723 is satisfied.

The solid electrolyte body 10 is made of partially stabilized zirconia. The measuring electrode 11, the outer lead section 111, the outer terminal section 112, the reference electrode 12, the inner lead section 121, and the inner terminal section 122 are all made of Pt (platinum).

The measuring electrode 11, the outer lead section 111, the outer terminal section 112, the reference electrode 12, the inner lead section 121, and the inner terminal section 122 are formed by a paste being printed in a desired shape by pad printing or the like on the outer surface 101 and the inner surface 102 of the solid electrolyte body 10. The paste contains dibenzylidene Pt that is a noble metal compound. The printed paste is then heat-treated, thereby forming a Pt core formation section. Electroless deposition is subsequently performed.

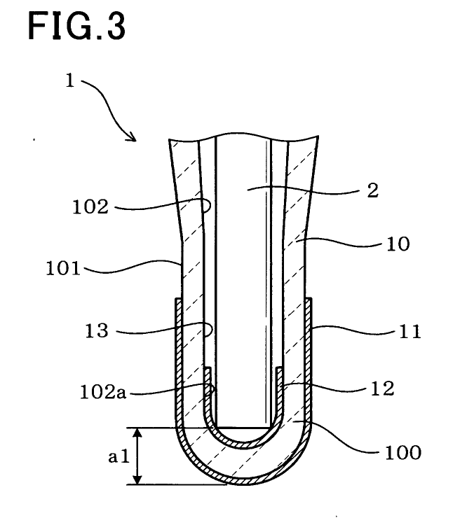

As shown in FIG. 3, a rod-shaped heater 2 is disposed such as to be inserted into the reference gas chamber 13. The heater 2 is in contact with a section of the measuring-electrode-opposing-region 102a on the inner surface 102 of the solid electrolyte body 10 in which the reference electrode 12 is formed. A heat element (not shown) is included within a tip end section 200 of the heater 2.

In a state in which the oxygen sensor element 1 is heated by the heater 2, a potential difference corresponding to an oxygen concentration difference between measured gas and reference gas occurs between the measuring electrode 11 and the reference electrode 12 of the solid electrolyte body 10. Oxygen concentration of the measured gas can be determined by the potential difference.

Next, a structure of an oxygen sensor 3 using the oxygen sensor element 1 according to the first embodiment will be described.

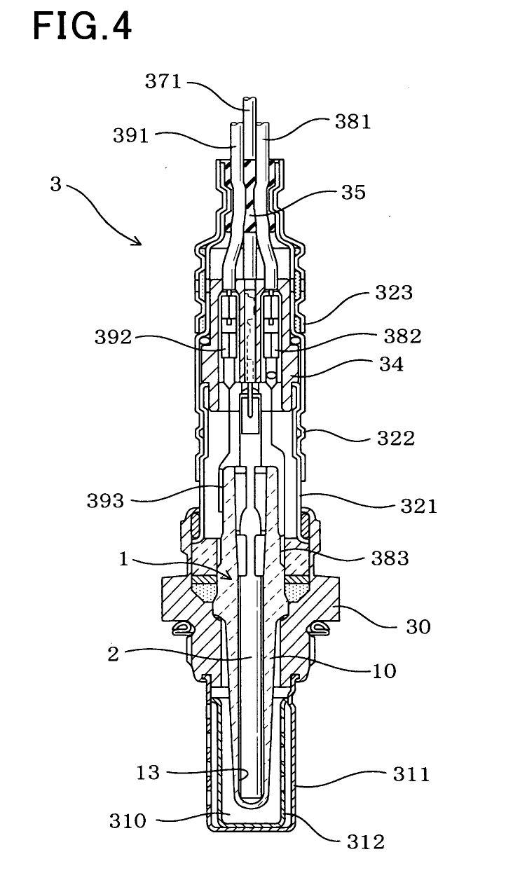

As shown in FIG. 4, the oxygen sensor 3 has a housing 30. The oxygen sensor element 1 is fixed to the housing 30 by being sealed. A measured gas chamber 310 is formed on a tip end side of the housing 30. Double measured-gas-side covers 311 and 312 that protect the oxygen sensor element 1 are also provided on the tip end side of the housing 30. Three-stage atmosphere-side covers 321, 322, and 323 are provided on a base end side of the housing 30.

As shown in FIG. 4, an elastic insulating member 35 into which lead lines 371, 381, and 391 are inserted is provided on a base end side of the atmosphere-side covers 322 and 323.

The lead line 371 energizes the heater 2 to generate heat. The lead lines 381 and 391 extract current generated in the solid electrolyte body 10 as signals, and send the signals outside.

As shown in FIG. 4, joining terminals 382 and 392 are provided on a tip end side of the lead lines 381 and 391. The joining terminals 382 and 392 come into contact with metal terminals 383 and 393 and conduct current. The metal terminals 383 and 393 are fixed to the oxygen sensor element 1.

The metal terminals 383 and 393 are respectively in contact with and fixed to the outer terminal section 112 and the inner terminal section 122 (see FIG. 1 and FIG. 2) of the oxygen sensor element 1.

Next, operational effects of the oxygen sensor element 1 according to the first embodiment will be described.

In the oxygen sensor element 1 according to the first embodiment, the measuring electrode 11 is formed surrounding the outer surface 101 of the tip end section 100 of the solid electrolyte body 10. The reference electrode 12 is formed within the measuring-electrode-opposing-region 102a of the inner surface 102 of the solid electrolyte body 10. The area S1 of the measuring electrode 11 and the area S2 of the reference electrode 12 satisfy a relationship 0.010≦S2/S1<0.723. As a result, the temperature of the oxygen sensor element 1 can be controlled with high accuracy.

In other words, the first embodiment is very characteristic in that, as a result of the area S2 of the reference electrode 12 in relation to the area S1 of the measuring electrode 11 being reduced by a predetermined range, a gradient of impedance of the solid electrolyte body 10 in relation to the temperature of the oxygen sensor element 1 (temperature gradient) is found to have increased. As a result of the increase in temperature gradient, the temperature of the oxygen sensor element 1 can be more accurately determined by detecting impedance. Therefore, when temperature control of the oxygen sensor element 1 is performed to stabilize sensor output, the temperature of the oxygen sensor element 1 can be controlled to a desired temperature with higher accuracy.

In addition, because the area S2 of the reference electrode 12 in relation to the area S1 of the measuring electrode 11 is reduced by a predetermined range, compared to when the area S1 of the measuring electrode 11 is fixed and the reference electrode 12 is formed over the overall measuring-electrode-opposing-region 102a, the electrode formation area of the reference electrode 12 can be reduced. As a result, the amount of use of the electrode material containing a noble metal such as Pt (platinum) can be reduced, thereby reducing cost.

In this way, according to the first embodiment, the oxygen sensor element 1 capable of controlling the element temperature with high accuracy, and reducing cost by reducing the electrode material can be provided.

### Second Embodiment

According to a second embodiment, performance tests of oxygen sensor element samples A1 to A12 were conducted as shown in Table 1A, Table 1B and Table 2.

The oxygen sensor elements of samples A1 to A12 have a structure similar to that of the oxygen sensor element according to the first embodiment. However, the configuration of the reference electrode differs with each sample.

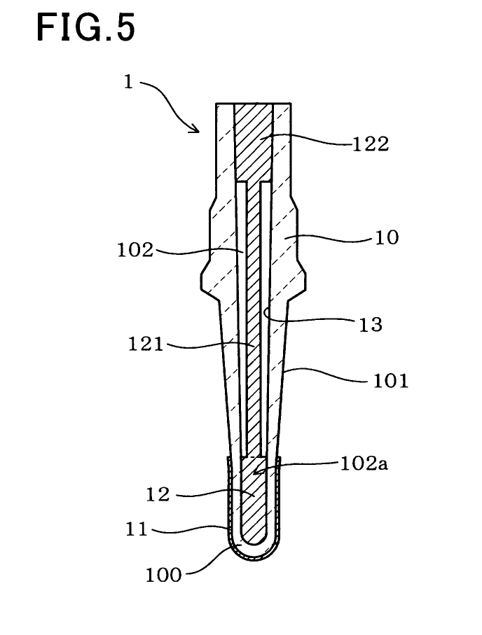

Specifically, sample A1 is a conventional product in which the reference electrode 12 is formed over the overall measuring-electrode-opposing-region 102a on the inner surface 102 of the solid electrolyte body 10, as shown in FIG. 5. As a result of the reference electrode 12 being formed in this way over the overall measuring-electrode-opposing-region 102a on the inner surface 102 of the solid electrolyte body 10, characteristics such as active time and responsiveness are ensured. In addition, directivity caused by contact direction of the exhaust gas in relation to the oxygen sensor element is prevented from occurring.

As shown in FIG. 2, in samples A2 and A3, the reference electrode 12 is formed over the overall periphery in the perpendicular to the axial direction on the tip end side of the measuring-electrode-opposing-region 102a. A tip length of the reference electrode 12 differs between the samples A2 and A3.

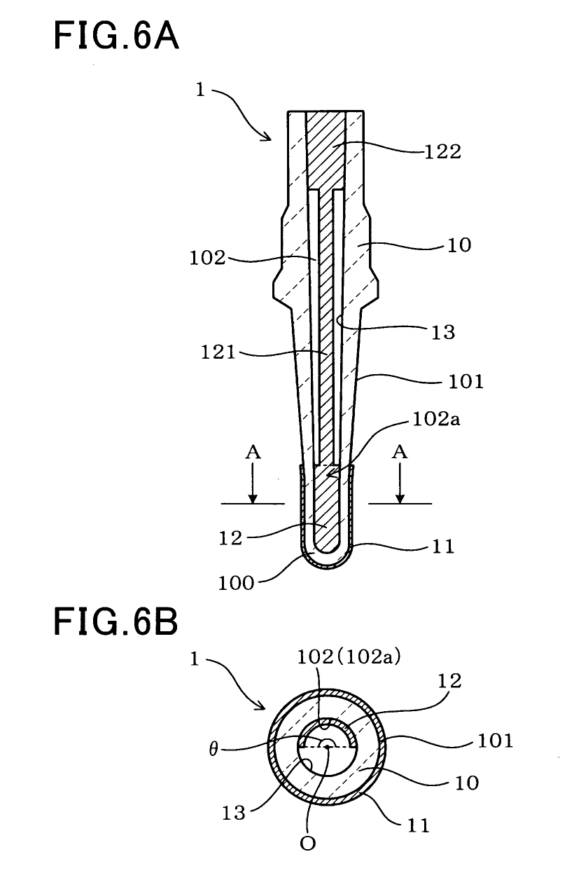

As shown in FIG. 6A and FIG. 68, in samples A4 to A11, the reference electrode 12 is formed continuously in the peripheral direction within the measuring-electrode-opposing-region 102a. A peripheral area of the reference electrode 12 is changed within a range of 9° to 180°. FIG. 6 shows the oxygen sensor element 1 of sample A4.

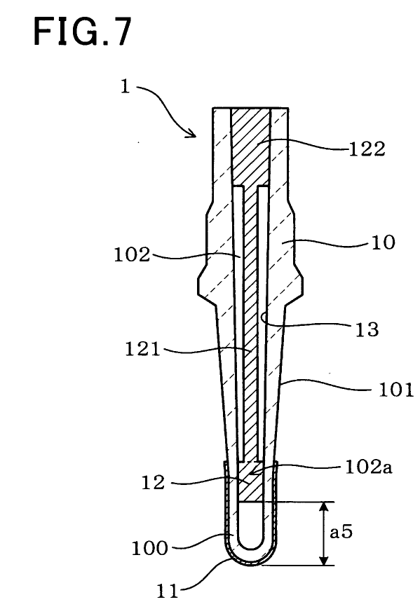

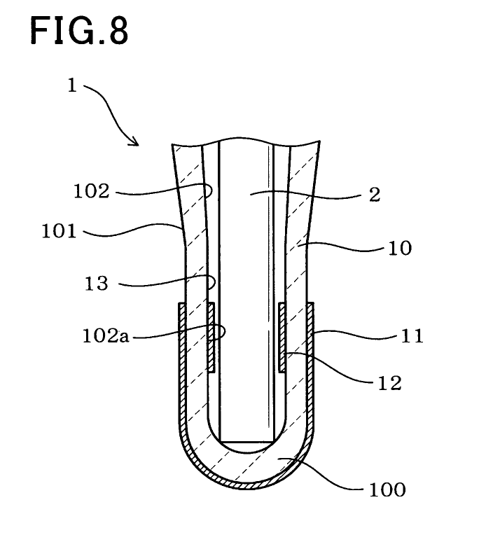

As shown in FIG. 7, in sample A12, the reference electrode 12 is formed over the overall periphery in the perpendicular to the axial direction on the base end side of the measuring-electrode-opposing-region 102a. As shown in FIG. 8, the heater 2 is in contact with a section in the measuring-electrode-opposing-region 102a of the inner surface 101 of the solid electrolyte body 10 in which the reference electrode 12 is not formed.

Next, each field of the oxygen sensor elements (samples A1 to A12) shown in Table 1A and Table 1B will be described.

A contact position (mm) of the heater is a distance a1 from the tip end of the oxygen sensor element 1 to the tip end of the heater 2 (see FIG. 3).

A tip length (mm) of the measuring electrode is a distance a2 from the tip end of the oxygen sensor element 1 to the posterior end of the measuring electrode 11 (see FIG. 1)

A lead peripheral length (mm) of the measuring electrode is a length a3 in the peripheral direction of the outer lead section 111 (see FIG. 1).

A tip length (mm) of the reference electrode is a distance a4 from the tip end of the oxygen sensor element 1 to the posterior end of the reference electrode 12 (see FIG. 2).

A peripheral width (mm) of the reference electrode is a length in the peripheral direction of the reference electrode 12.

An electrode edge position (mm) of the reference electrode is a distance a5 from the tip end of the oxygen sensor element 1 to the tip end of the reference electrode 12 (see FIG. 7).

A lead peripheral length (mm) of the reference electrode is a length a6 in the peripheral direction of the inner lead section 121 (see FIG. 2).

A peripheral angle (°) of the reference electrode is an angle θ formed by a shaft center O of the oxygen sensor element 1 and both ends of the reference electrode 12 in the peripheral direction (see FIG. 6B).

An area ratio S2/S1 is a ratio of the area S2 of the reference electrode 12 in relation to the area S1 of the measuring electrode 11.

TABLE 1A

| | Heater | Measuring Electrode | | |
|---|---|---|---|---|
| | Contact Position | Tip Length | Area | Lead Peripheral |
| | a1 | a2 | S1 | Length a3 |
| Sample No. | (mm) | (mm) | (mm²) | (mm) |
| A1 | 2 | 10 | 138.79 | 1.5 |
| A2 | 2 | 10 | 138.79 | 1.5 |
| A3 | 2 | 10 | 138.79 | 1.5 |
| A4 | 2 | 10 | 138.79 | 1.5 |
| A5 | 2 | 10 | 138.79 | 1.5 |
| A6 | 2 | 10 | 138.79 | 1.5 |
| A7 | 2 | 10 | 138.79 | 1.5 |
| A8 | 2 | 10 | 138.79 | 1.5 |
| A9 | 2 | 10 | 138.79 | 1.5 |
| A10 | 2 | 10 | 138.79 | 1.5 |
| A11 | 2 | 10 | 138.79 | 1.5 |
| A12 | 2 | 10 | 138.79 | 1.5 |

TABLE 1B

| | Reference Electrode | | | | | | |
|---|---|---|---|---|---|---|---|
| | | | | | Lead | | |
| | Tip Length | Peripheral | Distance | | Peripheral | Peripheral | |
| Sample | a4 | Length | a5 | Area S2 | Length a6 | Angle θ | Area Ratio |
| No. | (mm) | (mm) | (mm) | (mm²) | (mm) | (°) | S2/S1 |
| A1 | 10 | 10.68 | 0 | 100.41 | 1 | 360 | 0.723 |
| A2 | 5 | 10.68 | 0 | 47.00 | 1 | 360 | 0.339 |
| A3 | 3 | 10.68 | 0 | 25.64 | 1 | 360 | 0.185 |
| A4 | 10 | 5.34 | 0 | 50.20 | 1 | 180 | 0.362 |
| A5 | 10 | 3.56 | 0 | 33.47 | 1 | 120 | 0.241 |
| A6 | 10 | 1.78 | 0 | 16.73 | 1 | 60 | 0.121 |
| A7 | 10 | 1.07 | 0 | 10.04 | 1 | 36 | 0.072 |
| A8 | 10 | 0.53 | 0 | 5.02 | 1 | 18 | 0.036 |
| A9 | 10 | 0.31 | 0 | 2.87 | 1 | 10 | 0.021 |
| A10 | 10 | 0.31 | 0 | 1.34 | 1 | 10 | 0.010 |
| A11 | 10 | 0.27 | 0 | 1.17 | 1 | 9 | 0.008 |
| A12 | 10 | 10.68 | 5 | 53.40 | 1 | 360 | 0.385 |

Next, performance tests of the oxygen sensor elements (samples A1 to A12) shown in Table 2 will be described.

An output amplitude VA of when self-feedback of the oxygen sensor element is performed within model gas is measured using a model gas characteristic inspection device under conditions in which gas temperature is 400° C. and the element heater is OFF (no self-heating).

Judgment of VA is made as follows: ⊚ when 0.75V or more; ∘ when 0.65V or more and less than 0.75V; and x when less than 0.65V.

Regarding temperature gradient a, the element tip is heater in air to 550° C., 650° C., and 750° C. by heater energization using an electric furnace. At this time, the element resistance calculated from a current value obtained when an alternating current of 10 kHz is applied to the oxygen sensor element is measured. A relationship between element temperature X(° C.) and element resistance (impedance) Y(Ω) is expressed in a graph, and an approximate curve (fitted curve) Y=a·b^{x}(b: constant) is derived. As a result, the value a of the temperature gradient is determined.

Judgment of the temperature gradient a is made with reference to a temperature gradient a of 88.2 of sample A1 that is the conventional product in which the measuring electrode and an opposing electrode are provided in opposing positions. The temperature gradient a is judged to be x when 88.2 or less, ∘ when greater than 88.2 and 98.2 or less, and ⊚ when greater than 98.2.

TABLE 2

| | Sensor Characteristics | | | | | | |
|---|---|---|---|---|---|---|---|
| | VA | | | | | | Temperature |
| Sample | (V) | Judgement | Zac (Ω) | | | Temperature | Gradient |
| No. | 400° C. | of VA | 550° C. | 650° C. | 750° C. | Gradient a | Judgment |
| A1 | 0.81 | ⊚ | 122.0 | 34.3 | 19.6 | 88.2 | — |
| A2 | 0.81 | ⊚ | 153.0 | 38.5 | 19.8 | 97.0 | ◯ |
| A3 | 0.81 | ⊚ | 172.0 | 40.3 | 20.0 | 115.7 | ⊚ |
| A4 | 0.81 | ⊚ | 244.0 | 68.6 | 39.2 | 91.8 | ◯ |
| A5 | 0.81 | ⊚ | 366.0 | 102.9 | 58.8 | 109.5 | ⊚ |
| A6 | 0.81 | ⊚ | 732.0 | 205.8 | 117.6 | 148.0 | ⊚ |
| A7 | 0.81 | ⊚ | 1220.0 | 343.0 | 196.0 | 184.7 | ⊚ |
| A8 | 0.81 | ⊚ | 2440.0 | 686.0 | 392.0 | 249.6 | ⊚ |
| A9 | 0.81 | ⊚ | 4270.0 | 1200.5 | 686.0 | 318.3 | ⊚ |
| A10 | 0.81 | ⊚ | 5355.0 | 1347.5 | 693.0 | 454.5 | ⊚ |
| A11 | 0.81 | ⊚ | 6120.0 | 1540.0 | 792.0 | 481.6 | ⊚ |
| A12 | 0.83 | ⊚ | 618.0 | 124.0 | 84.0 | 188.2 | ⊚ |

Next, the results of the performance tests conducted on the oxygen sensor elements (samples A1 to A12) shown in Table 2 will be described.

Regarding all samples A2 to A12 having a smaller area ratio S2/S1 than the area ratio S2/S1 (=0.723) of the conventional product sample A1, the temperature gradient judgment was ∘ or ⊚, and the VA judgment was ⊚.

Regarding sample A11 having an area ratio S2/S1 that is less than 0.010, the area S2 of the reference electrode in relation to the area S1 of the measuring electrode is extremely small. Therefore, conduction defect may occur between the measuring electrode and the reference electrode.

The above-described results indicate that the temperature gradient a can be increased by setting the area ratio S2/S1 within the range of the present invention, namely 0.010≦S2/S1<0.723, as in samples A2 to A10 and A12. It is also evident that the temperature of the oxygen sensor element can be controlled to a desired temperature with higher accuracy.

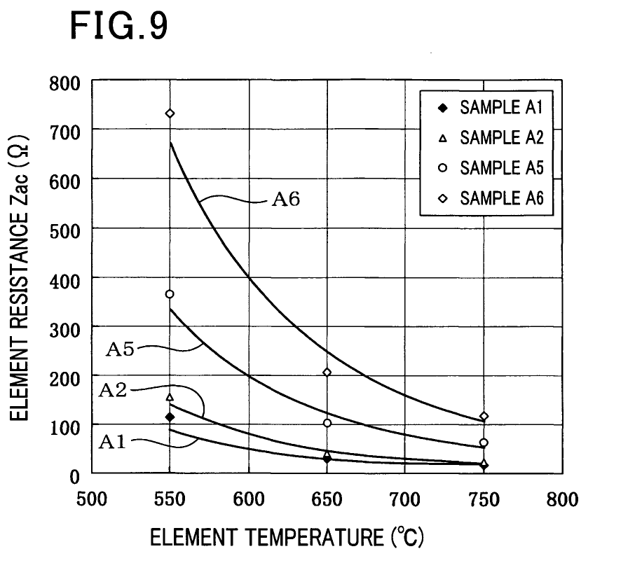

FIG. 9 shows a relationship between element temperature X(° C.) and element resistance (impedance) Y(C) of the conventional product sample A1 and the present invention product samples A2, A5, and A6.

As FIG. 9 shows, the temperature gradient a of the present invention product samples A2, A5, and A6 is greater than that of the conventional product sample A1. The temperature gradient a of the present invention products increase as the area ratio S2 to S1 decreases.

### Third Embodiment

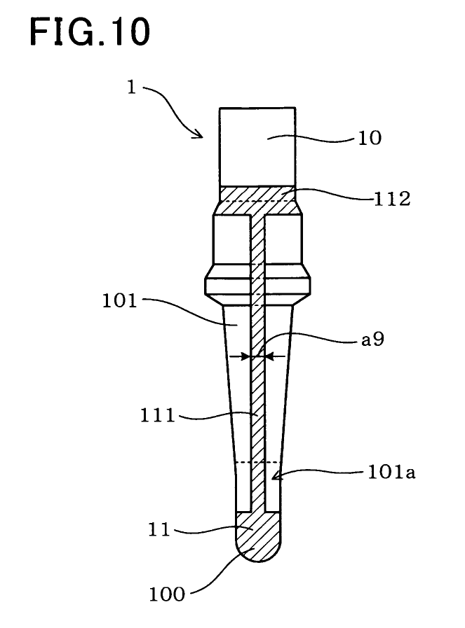

A third embodiment is an example in which the configurations of the measuring electrode 11 and the reference electrode 12 are changed as shown in FIG. 10 to FIG. 12.

According to the third embodiment, as shown in FIG. 10, the reference electrode 12 is formed over the overall periphery in the perpendicular to the axial direction such as to surround the inner surface 102 in the tip end section 100 of the solid electrolyte body 10.

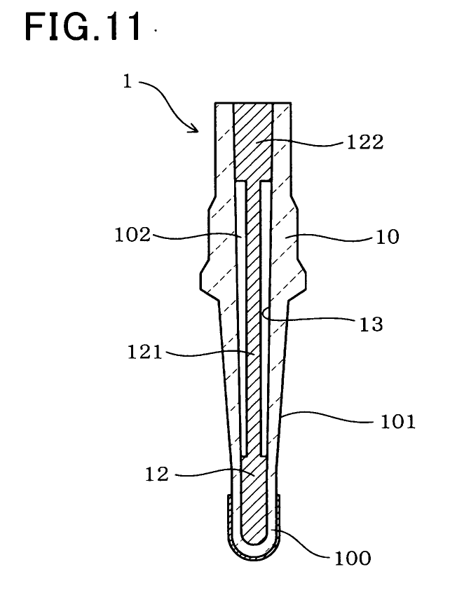

As shown in FIG. 11, the measuring electrode 11 is formed within a reference-electrode-opposing-region 101a that is a region on the outer surface 101 of the solid electrolyte body 10 opposing the reference electrode 12 with the solid electrolyte body 10 therebetween. According to the third embodiment, the measuring electrode 11 is formed over the overall periphery in the perpendicular to the axial direction on the tip end side of the reference-electrode-opposing-region 101a.

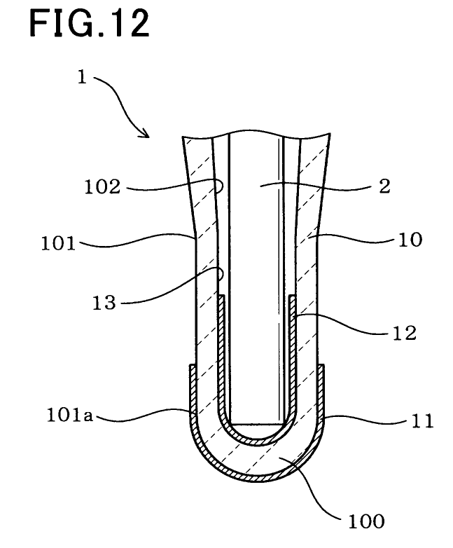

As shown in FIG. 12, the heater 2 is in contact with a position on the inner surface 102 of the solid electrolyte body 10 opposing the measuring electrode 11.

As shown in FIG. 10 and FIG. 11, with an electrode formation area of the measuring electrode 11 formed on the outer surface 101 of the solid electrolyte body 10 as S1 and an electrode formation area of the reference electrode 12 formed within the measuring-electrode-opposing-region 102a on the inner surface 102 of the solid electrolyte body 10 as S2, a relationship 0.05≦S1/S2<1.38 is satisfied.

Other configurations are similar to those according to the first embodiment.

Next, operational effects of the oxygen element sensor 1 according to the third embodiment will be described.

Contrary to the first embodiment, the third embodiment is very characteristic in that the temperature gradient is found to have increased by the area S1 of the measuring electrode 11 in relation to the area S2 of the reference electrode 12 being reduced by a predetermined range. As according to the first embodiment, as a result of the increase in temperature gradient, temperature variation of the oxygen sensor element 1 can be more accurately determined by detecting impedance. Therefore, stable sensor output can be achieved by controlling the temperature of the oxygen sensor element to a desired temperature with higher accuracy.

Because the area S1 of the measuring electrode 11 in relation to the area S2 of the reference electrode 12 is reduced by a predetermined range, compared to when the area S2 of the reference electrode 12 is fixed and the measuring electrode 11 is formed in the overall reference-electrode-opposing-region 101a, the electrode formation area of the measuring electrode 11 can be reduced. As a result, the amount of use of an electrode material containing a noble metal such as Pt (platinum) can be reduced, thereby reducing cost.

Therefore, according to the third embodiment, the oxygen sensor element 1 capable of more accurately controlling the element temperature and reducing cost by reducing electrode materials can be provided.

### Fourth Embodiment

According to a fourth embodiment, performance tests of oxygen sensor element samples B1 to B23 were conducted as shown in Table 3A, 3B to Table 6A, 6B.

The oxygen sensor elements of samples B1 to B23 have a structure similar to that of the oxygen sensor element according to the third embodiment. However, the configuration of the measuring electrode differs with each sample.

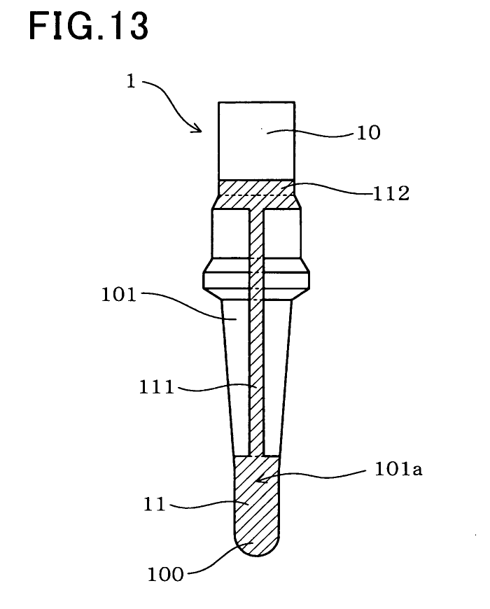

Specifically, sample B1 is a conventional product in which the measuring electrode 11 is formed over the overall reference-electrode-opposing-region 101a on the outer surface 101 of the solid electrolyte body 10, as shown in FIG. 13.

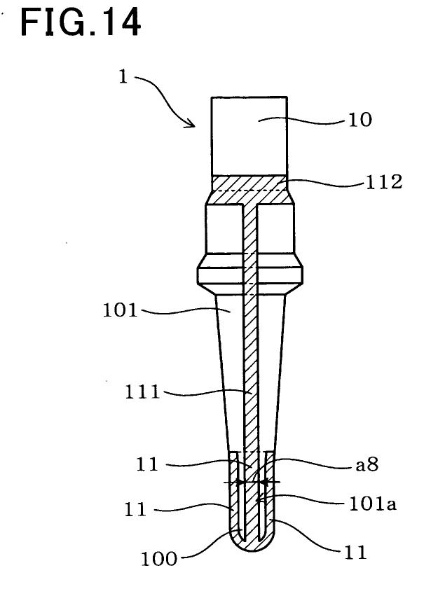

As shown in FIG. 14, in samples B2 to B6 and B17 to B20, the measuring electrode 11 is formed within the reference-electrode-opposing-region 101a and is segmented in the peripheral direction. An axis angle, the number of detecting elements, and the width of the detecting element differ with each sample. FIG. 14 shows the oxygen sensor element 1 of sample B18.

As shown in FIG. 10, in samples B7 and B8, the measuring electrode 11 is formed over the overall periphery in the perpendicular to the axial direction such as to surround the outer surface 101 in the tip end section 100 of the solid electrolyte body 10. The tip length of the measuring electrode 11 differs with each sample.

As shown in FIG. 10, in samples B9 to B16, the measuring electrode 11 is formed within the reference-electrode-opposing-region 101a continuously or segmented in the peripheral direction. A peripheral length, the number of detecting elements, the width of the detection element, and a peripheral area of the measuring electrode 11 differ with each sample.

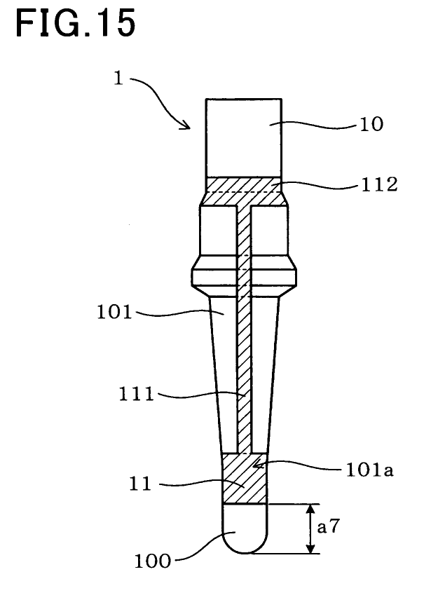

As shown in FIG. 15, in samples B21 to B23, the measuring electrode 11 is formed over the overall periphery in the perpendicular to the axial direction on the base end side of the reference-electrode-opposing-region 101a. The tip length and the electrode edge position of the measuring electrode 11 differ with each sample. FIG. 15 shows the oxygen sensor element 1 of sample B23.

Next, each dimension of the oxygen sensor elements (samples B1 to B23) shown in Table 3A, 3B and Table 4A, 4B will be described. Descriptions of fields that are the same as those in Table 1A and Table 1B according to the second embodiment will be omitted.

A peripheral length (mm) of the measuring electrode is a length of the measuring electrode 11 in the peripheral direction. When the measuring electrode 11 is segmented, the peripheral length is a sum of the length of each measuring electrode 11 in the peripheral direction.

An electrode edge position (mm) of the measuring electrode is a distance a7 from the tip of the oxygen sensor element 1 to the tip of the measuring electrode 11 (see FIG. 15).

An axis angle (°) of the measuring electrode is an angle between rotational symmetry axes with the shaft center of the oxygen sensor element 1 as the center.

The number of detecting elements of the measuring electrode is the number of segmentations in the measuring electrode 11 in the peripheral direction.

A width of the detecting element (mm) of the measuring electrode is a width a8 in the peripheral direction of each measuring electrode 11 segmented in the peripheral direction (see FIG. 14).

A lead peripheral length (mm) of the measuring electrode is a length a9 of the outer lead section 111 in the peripheral direction (see FIG. 10).

A peripheral angle (°) of the measuring electrode is an angle formed by the shaft center of the oxygen sensor element 1 and both ends of the measuring electrode 11 (each segmented measuring electrode 11 when segmented in the peripheral direction) in the peripheral direction.

The area ratio S1/S2 is a ratio of the area S1 of the measuring electrode 11 in relation to the area S2 of the reference electrode 12.

TABLE 3A

| | | Measuring Electrode | | | | | |
|---|---|---|---|---|---|---|---|
| | Heater | | | | | | Width of |
| | Contact | Tip Length | Peripheral | Distance | Axis | Number of | Detecting |
| Sample | Position a1 | a2 | Length | a7 | Angle | Detecting | Element a8 |
| No. | (mm) | (mm) | (mm) | (mm) | (°) | Elements | (mm) |
| B1 | 2 | 10 | 13.98 | 0 | 360 | 1 | 13.98 |
| B2 | 2 | 10 | 3.50 | 0 | — | 1 | 3.50 |
| B3 | 2 | 10 | 3.50 | 0 | 180 | 2 | 1.75 |
| B4 | 2 | 10 | 3.60 | 0 | 120 | 3 | 1.17 |
| B5 | 2 | 10 | 3.50 | 0 | 90 | 4 | 0.88 |
| B6 | 2 | 10 | 3.50 | 0 | 30 | 6 | 0.58 |
| B7 | 2 | 5 | 13.98 | 0 | 360 | 1 | 13.98 |
| B8 | 2 | 3 | 13.98 | 0 | 360 | 1 | 13.98 |

TABLE 3B

| | Measuring Electrode | | | Reference Electrode | | |
|---|---|---|---|---|---|---|
| | | Lead | | Tip | | |
| | Area | Peripheral | Peripheral | Length | Area | Area |
| Sample | S1 | Length a3 | Angle | a4 | S2 | Ratio |
| No. | (mm²) | (mm) | (°) | (mm) | (mm²) | S1/S2 |
| B1 | 138.8 | 1.5 | 360 | 10 | 100.4 | 1.38 |
| B2 | 89.7 | 3.5 | 90 | 10 | 100.4 | 0.89 |
| B3 | 89.7 | 3.5 | 90 | 10 | 100.4 | 0.89 |
| B4 | 89.7 | 3.5 | 90 | 10 | 100.4 | 0.89 |
| B5 | 89.7 | 3.5 | 90 | 10 | 100.4 | 0.89 |
| B6 | 89.7 | 3.5 | 90 | 10 | 100.4 | 0.89 |
| B7 | 68.9 | 1.5 | 360 | 10 | 100.4 | 0.69 |
| B8 | 40.9 | 1.5 | 360 | 10 | 100.4 | 0.41 |

TABLE 4A

| | | Measuring Electrode | | | | | |
|---|---|---|---|---|---|---|---|
| | Heater | | | | | | Width of |
| | Contact | Tip Length | Peripheral | Distance | Axis | Number of | Detecting |
| Sample | Position a1 | a2 | Length | a7 | Angle | Detecting | Element a8 |
| No. | (mm) | (mm) | (mm) | (mm) | (°) | Elements | (mm) |
| B9 | 2 | 10 | 6.99 | 0 | 180 | 1 | 6.99 |
| B10 | 2 | 10 | 6.99 | 0 | 180 | 2 | 3.50 |
| B11 | 2 | 10 | 3.50 | 0 | 180 | 2 | 1.75 |
| B12 | 2 | 10 | 1.75 | 0 | 180 | 2 | 0.87 |
| B13 | 2 | 10 | 1.00 | 0 | 180 | 2 | 0.50 |
| B14 | 2 | 10 | 0.80 | 0 | 180 | 2 | 0.40 |
| B15 | 2 | 10 | 0.60 | 0 | 180 | 2 | 0.30 |
| B16 | 2 | 10 | 0.50 | 0 | 180 | 2 | 0.25 |
| B17 | 2 | 10 | 6.99 | 0 | 120 | 3 | 2.33 |
| B18 | 2 | 10 | 6.99 | 0 | 90 | 4 | 1.75 |
| B19 | 2 | 10 | 6.99 | 0 | 60 | 6 | 1.17 |
| B20 | 2 | 10 | 6.99 | 0 | 30 | 12 | 0.58 |
| B21 | 2 | 7 | 13.98 | 2 | 360 | 1 | 2.00 |
| B22 | 2 | 9 | 13.98 | 4 | 360 | 1 | 4.00 |
| B23 | 2 | 10 | 13.98 | 5 | 360 | 1 | 5.00 |

TABLE 4B

| | Measuring Electrode | | | Reference | | |
|---|---|---|---|---|---|---|
| | | Lead | | Electrode | | |
| | | Peripheral | Peripheral | Tip Length | | Area |
| Sample | Area S1 | Length a3 | Angle | a4 | Area S2 | Ratio |
| No. | (mm²) | (mm) | (°) | (mm) | (mm²) | S1/S2 |
| B9 | 54.4 | 1.5 | 180 | 10 | 100.4 | 0.54 |
| B10 | 54.4 | 1.5 | 180 | 10 | 100.4 | 0.54 |
| B11 | 27.2 | 1.5 | 90 | 10 | 100.4 | 0.27 |
| B12 | 13.6 | 1.5 | 45 | 10 | 100.4 | 0.14 |
| B13 | 7.8 | 1.5 | 25.8 | 10 | 100.4 | 0.08 |
| B14 | 6.2 | 1.5 | 20.6 | 10 | 100.4 | 0.06 |
| B15 | 4.7 | 1.5 | 15.5 | 10 | 100.4 | 0.05 |
| B16 | 3.9 | 1.5 | 12.9 | 10 | 100.4 | 0.04 |
| B17 | 54.4 | 1.5 | 180 | 10 | 100.4 | 0.54 |
| B18 | 54.4 | 1.5 | 180 | 10 | 100.4 | 0.54 |
| B19 | 54.4 | 1.5 | 180 | 10 | 100.4 | 0.54 |
| B20 | 54.4 | 1.5 | 180 | 10 | 100.4 | 0.54 |
| B21 | 69.9 | 2.5 | 360 | 10 | 100.4 | 0.70 |
| B22 | 69.9 | 3.5 | 360 | 10 | 100.4 | 0.70 |
| B23 | 69.9 | 4.5 | 360 | 10 | 100.4 | 0.70 |

Next, performance tests conducted on the oxygen sensor elements (samples B1 to B23) shown Table 5A, 5B and Table 6A, 6B will be described.

VA is determined by a method similar to that according to the second embodiment. Judgment of VA is also made in a similar manner.

The temperature gradient a is determined by a method similar to that according to the second embodiment. Judgment of the temperature gradient a is made with reference to a temperature gradient a of 88.2 of sample B1 that is the conventional product in which the measuring electrode and an opposing electrode are provided in opposing positions. The temperature gradient a is judged to be x when 88.2 or less, ∘ when greater than 88.2 and 98.2 or less, and ⊚ when greater than 98.2.

Responsiveness is determined by measuring a sum of an output change time from rich to lean and an output change time from lean to rich during forced step-response between rich and lean, in engine bench evaluation under conditions in which gas temperature is 400° C. and element temperature is 550° C. Response difference is measured by a difference (responsiveness difference (ms)) between the sum of the output change times measured in one direction and the sum of the output change time measured after rotation by 180°.

Responsiveness is judged to be x when the responsiveness difference is 400 ms or more, and a when less than 400 ms.

TABLE 5A

| | Sensor Characteristics | | | | |
|---|---|---|---|---|---|
| | VA | | | | |
| | (V) | Judgment | Zac (Ω) | | |
| SampleNo. | 400° C. | of VA | 550° C. | 650° C. | 750° C. |
| B1 | 0.81 | ⊚ | 112.0 | 27.5 | 11.9 |
| B2 | 0.81 | ⊚ | 448.0 | 110.0 | 47.6 |
| B3 | 0.81 | ⊚ | 448.0 | 110.0 | 47.6 |
| B4 | 0.81 | ⊚ | 448.0 | 110.0 | 47.6 |
| B5 | 0.81 | ⊚ | 448.0 | 110.0 | 47.6 |
| B6 | 0.81 | ⊚ | 448.0 | 110.0 | 47.6 |
| B7 | 0.81 | ⊚ | 152.0 | 38.7 | 14.8 |
| B8 | 0.81 | ⊚ | 171.0 | 40.5 | 17.3 |

TABLE 5B

| | Sensor Characteristics | | | |
|---|---|---|---|---|
| | | Temperature | Response | |
| | Temperature | Gradient | Difference | Responsiveness |
| Sample No. | Gradient a | Judgment | (ms) | Judgment |
| B1 | 88.2 | — | 205 | ◯ |
| B2 | 164.0 | ⊚ | 443 | X |
| B3 | 148.4 | ⊚ | 250 | ◯ |
| B4 | 148.4 | ⊚ | 210 | ◯ |
| B5 | 148.4 | ⊚ | 204 | ◯ |
| B6 | 148.4 | ⊚ | 200 | ◯ |
| B7 | 99.5 | ⊚ | 200 | ◯ |
| B8 | 104.6 | ⊚ | 203 | ◯ |

TABLE 6A

| | Sensor characteristics | | | | |
|---|---|---|---|---|---|
| | VA | Judgement | | | |
| | (V) | of | Zac (Ω) | | |
| Sample No. | 400° C. | VA | 550° C. | 650° C. | 750° C. |
| B9 | 0.81 | ⊚ | 224.0 | 55.0 | 23.8 |
| B10 | 0.81 | ⊚ | 224.0 | 55.0 | 23.8 |
| B11 | 0.81 | ⊚ | 448.0 | 110.0 | 47.6 |
| B12 | 0.81 | ⊚ | 896.0 | 220.0 | 95.2 |
| B13 | 0.81 | ⊚ | 1565.8 | 384.5 | 166.4 |
| B14 | 0.81 | ⊚ | 1957.2 | 480.6 | 208.0 |
| B15 | 0.81 | ⊚ | 2609.6 | 640.8 | 277.3 |
| B16 | 0.81 | ⊚ | 3131.5 | 768.9 | 332.7 |
| B17 | 0.81 | ⊚ | 224.0 | 55.0 | 23.8 |
| B18 | 0.81 | ⊚ | 224.0 | 55.0 | 23.8 |
| B19 | 0.81 | ⊚ | 224.0 | 55.0 | 23.8 |
| B20 | 0.81 | ⊚ | 224.0 | 55.0 | 23.8 |
| B21 | 0.81 | ⊚ | 152.0 | 38.7 | 14.8 |
| B22 | 0.81 | ⊚ | 500.0 | 25.0 | 40.0 |
| B23 | 0.81 | ⊚ | 650.0 | 300.0 | 50.0 |

TABLE 6B

| | Sensor Characteristics | | | |
|---|---|---|---|---|
| | | Temperature | Response | |
| | Temperature | Gradient | Difference | Responsiveness |
| Sample No. | Gradient a | Judgment | (ms) | Judgment |
| B9 | 117.9 | ⊚ | 403 | X |
| B10 | 117.9 | ⊚ | 240 | ◯ |
| B11 | 160.8 | ⊚ | 241 | ◯ |
| B12 | 219.2 | ⊚ | 243 | ◯ |
| B13 | 275.9 | ⊚ | 245 | ◯ |
| B14 | 308.0 | ⊚ | 248 | ◯ |
| B15 | 347.2 | ⊚ | 250 | ◯ |
| B16 | 372.4 | ⊚ | 250 | ◯ |
| B17 | 117.9 | ⊚ | 205 | ◯ |
| B18 | 117.9 | ⊚ | 204 | ◯ |
| B19 | 117.9 | ⊚ | 203 | ◯ |
| B20 | 117.9 | ⊚ | 197 | ◯ |
| B21 | 99.5 | ⊚ | 204 | ◯ |
| B22 | 181.3 | ⊚ | 205 | ◯ |
| B23 | 196.4 | ⊚ | 210 | ◯ |

Next, results of the performance tests conducted on the oxygen sensor elements (samples B1 to B23) shown in Table 5A, 5B and Table 6A, 6B will be described.

Regarding all samples B2 to B23 having a smaller area ratio S1/S2 than the area ratio S1/S2 (▭4.38) of the conventional product sample B1, the temperature gradient judgment was ⊚, and the VA judgment was ⊚. The responsiveness judgment was x for samples B2 and B9 in which the number of detecting elements is one and the measuring electrode is not disposed to be axially symmetrical. The responsiveness judgment was ∘ for other samples.

Regarding sample B16 having an area ratio S1/S2 that is less than 0.05, the area S1 of the measuring electrode in relation to the area S2 of the reference electrode is extremely small. Therefore, conduction defect may occur between the measuring electrode and the reference electrode.

The above-described results indicate that the temperature gradient a can be increased by setting the area ratio S1/S2 within the range of the present invention, namely 0.05≦S1/S2<1.38, as in samples B2 to B15 and B17 to B23. It is also evident that the temperature of the oxygen sensor element can be controlled to a desired temperature with higher accuracy.

What is claimed is:

1. An oxygen sensor element including a cup-shaped solid electrolyte body having a closed tip end and an open base end, and inside of which a reference gas chamber is provided; a measuring electrode that is formed on an outer surface of the solid electrolyte body and comes into contact with measured gas; and a reference electrode that is formed on an inner surface of the solid electrolyte body, wherein the heater is disposed inside the reference gas chamber, wherein
the measuring electrode is formed surrounding the outer surface in a tip end section of the solid electrolyte body,
the reference electrode is formed in a measuring-electrode-opposing-region that is a region on the inner surface of the solid electrolyte body opposing the measuring electrode with the solid electrolyte body therebetween,
the area S1 of the measuring electrode and the area S2 of the reference electrode satisfy a relationship 0.010≦S2/S1<0.723.

2. The oxygen sensor element according to claim 1, wherein
the heater is in contact with a section in which the reference electrode is formed, in a measuring-electrode-opposing-region on the inner surface of the solid electrolyte body, the area S1 of the measuring electrode and the area S2 of the reference electrode satisfy a relationship 0.185≦S2/S1<0.723.

3. The oxygen sensor element according to claim 1, wherein
the reference electrode is continuously formed in the peripheral direction within the measuring-electrode-opposing-region on the inner surface of the solid electrolyte body,
an angle formed by the shaft center of the oxygen sensor element and both ends of the reference electrode in the peripheral direction is 10° to 360°,
the heater is in contact with the measuring-electrode-opposing-region on the inner surface of the solid electrolyte body, and
the reference electrode is formed in at least a portion of the contact section.

4. The oxygen sensor element according to claim 1, wherein
the heater is in contact with a section in which the reference electrode is formed, in a measuring-electrode-opposing-region on the inner surface of the solid electrolyte body,
the area S1 of the measuring electrode and the area S2 of the reference electrode satisfy a relationship 0.185≦S2/S1<0.723.

5. An oxygen sensor element including a cup-shaped solid electrolyte body having a closed tip end and an open base end, and inside of which a reference gas chamber is provided; a measuring electrode that is formed on an outer surface of the solid electrolyte body and comes into contact with measured gas; and a reference electrode that is formed on an inner surface of the solid electrolyte body, wherein the heater is disposed inside the reference gas chamber, wherein
the reference electrode is formed surrounding the inner surface in a tip end section of the solid electrolyte body,
the measuring electrode is formed in a reference-electrode-opposing-region that is a region on the outer surface of the solid electrolyte body opposing the reference electrode with the solid electrolyte body therebetween,
the area S2 of the reference electrode and the area S1 of the measuring electrode satisfy a relationship 0.05≦S1/S2<1.38.

6. The oxygen sensor element according to claim 5, wherein
the heater is in contact with a position opposing the measuring electrode on the inner surface of the solid electrolyte body,
the area S2 of the reference electrode and the area S1 of the measuring electrode satisfy a relationship 0.41≦S1/S2<1.38.

7. The oxygen sensor element according to claim 5, wherein
the measuring electrode is formed segmented in the peripheral direction within a reference-electrode-opposing-region on the outer surface of the solid electrolyte body,
the heater is at least partially in contact with the position opposing the measuring electrode on the inner surface of the solid electrolyte body.

8. A gas sensor including an oxygen sensor element according to claim 1.

9. A gas sensor including an oxygen sensor element according to claim 5.
